(19) United States
(12) Patent Application Publication
(10) Pub. No.: US 2009/0216961 A1
(43) Pub. Date: Aug. 27, 2009

(54) MULTI-PORT SEMICONDUCTOR MEMORY DEVICE FOR REDUCING DATA TRANSFER EVENT AND ACCESS METHOD THEREFOR

(76) Inventor: Jin-Hyung KWON, Seongnam-si (KR)

Correspondence Address: F. CHAU & ASSOCIATES, LLC, 130 WOODBURY ROAD, WOODBURY, NY, 11797, US

(21) Appl. No.: 12/372,205

(22) Filed: Feb. 17, 2009

(30) Foreign Application Priority Data
Feb. 27, 2008 (KR) 10-2008-0017588

(51) Int. Cl. G06F 12/00; G06F 13/24

(52) U.S. Cl. 711/149; 711/150; 710/260; 711/E12.001

(57) ABSTRACT

A multiport semiconductor memory device includes at least three port units coupled respectively to corresponding processors, a shared memory area accessed in common by the processors through the port units, and a data path control unit for controlling a data path between the shared memory area and the port units to perform a data communication between the processors through the shared memory area.

### CROSS-REFERENCE TO RELATED APPLICATIONS

This application claims priority under 35 U.S.C. §119 to Korean Patent Application 10-2008-0017588, filed on Feb. 27, 2008, the disclosure of which is incorporated by reference in its entirety herein.

### BACKGROUND

1. Technical Field

The present disclosure relates to multiport semiconductor memory devices, and more particularly, to a semiconductor memory device having a shared memory area accessed through a multipath and a multiprocessor system having the same.

2. Discussion of Related Art

Multimedia electronic devices such as handheld telephones may include multimedia functions for playing music, games, movies, operating a camera, paying bills, etc., in addition to basic phone functions.

In a multiprocessor system, a semiconductor memory employed to store processing data may include a plurality of access ports. The memory may be required to simultaneously input and output data through the plurality of access ports.

A semiconductor memory device having two access ports is called a dual-port memory. One conventional dual-port memory includes a random access memory (RAM) port accessible in a random sequence and a serial access memory (SAM) port accessible in a serial sequence. A semiconductor memory having multiple access ports is called a multi-port memory or a multi-path access memory. One conventional multi-port memory includes a dynamic random access memory (DRAM). The multi-port memory does not employ an SAM port and a portion of the DRAM is a shared memory area. The shared memory area is a memory cell array of DRAM cells, which is accessible by respective processors through a plurality of access ports.

FIG. 1 illustrates a block diagram of a conventional multiprocessor system having a multi-port memory, which includes a shared memory area accessible by a plurality of processors. Referring to FIG. 1, the multiprocessor system 50 includes a memory array 35, a first processor 70, and a second processor 80. The memory array 35 includes a first memory portion 33, a second memory portion 31, and a third memory portion 32. The first memory portion 33 of the memory array 35 is accessed only by a first processor 70 through a port 37, the second memory portion 31 is accessed only by a second processor 80 through a port 38, and the third memory portion 32 is accessed by both the first and second processors 70 and 80.

However, it can be difficult to manage the sharing of the third memory portion 32 amongst the first and second processors 70 and 80. This difficulty is further exacerbated when a third processor is added to the system.

Thus, there is a need for methods and systems that employ a DRAM including a shared memory, which can be easily accessed by three or more processors.

### SUMMARY

According to an embodiment of the invention, a multiport semiconductor memory device comprises at least three port units coupled respectively to corresponding processors, a memory cell array comprising a shared memory area accessed in common by the processors through the port units, and a data path control unit for controlling a data path between the shared memory area and the port units to perform a data communication between the processors through the shared memory area.

The multiport semiconductor memory device may further comprise dedicated memory areas dedicatedly accessed by the processors. The data path control unit may comprise an internal register for storing data needed for a control of the data path. The internal register may be accessed by a source outside the memory cell array, instead of an area of the shared memory area, when an address to access the area of the shared memory area is applied.

The internal register may comprise a semaphore area for storing a control authority among the port units for the shared memory area and the internal register may comprise mailbox areas individually assigned to each of the processors, for storing a message to be applied to respective processors corresponding to a data transmission direction.

The shared memory may be a memory bank unit of the memory cell array. The data path control unit may comprise an internal register for storing data needed for a control of the data path, an interrupt driver coupled to the internal register, for applying interrupt signals corresponding to the respective port units to prevent two or more processors from simultaneously accessing the shared memory area, and a switching unit coupled to the internal register, for switching a data path between the shared memory area and a port unit corresponding to a processor having a control authority among the port units.

Data written to the shared memory area by a first processor among the processors may be available for a data processing in the shared memory area by an access of a second processor without a transmission to the second processor for the data processing. The processed data may be transmitted to a communication processor.

According to another exemplary embodiment of the invention, a multiprocessor system comprises a first processor for performing a first task, a second processor for performing a second task, a third processor for performing a third task, and a multiport semiconductor memory device. The multiport semiconductor memory device includes first, second and third port units individually coupled to the corresponding processors, a shared memory area accessed in common by the processors through the port units, and a data path control unit for controlling a data path between the shared memory area and the port units to perform a data communication between the processors through the shared memory area.

The first task may comprise a communication modulation/demodulation (MODEM) function. The second task may comprise a function of processing multimedia information. The third task may comprise a function of processing image information provided from a charge coupled device (CCD).

The multiprocessor system may be one of a vehicle-use mobile phone, a portable multimedia player (PMP), a personal digital assistant PDA, or a portable phone. The multiprocessor system may further comprise a NAND type flash memory that is accessed by the second processor.

According to another exemplary embodiment of the present invention, a method of accessing a multiport semiconductor memory device in a multiprocessor system, comprises controlling the port units of the multiport semiconductor memory device to write data to the shared memory area using a first processor operatively coupled to the memory device, controlling the port units to access the shared memory area by a second processor operatively coupled to the memory device and performing a processing of the written data in the shared memory area, and controlling the port units to access the shared memory area by a third processor operatively coupled to the memory device and transmit the converted data to a source external to the system.

When the first processor is a communication processor and the second processor is an application processor, the third processor may be an image processing processor. The multiprocessor system may be one of a vehicle-use mobile phone, a portable media player (PMP), a PSP, a portable media player (PDA), or a portable phone.

The controlling of the port units may be performed by using an internal register for storing data needed for a switching of the port units. The internal register may be accessed by the external source when an address to access an area of the shared memory area is applied. The internal register may include a semaphore area for storing a control authority among the port unit for the shared memory.

### BRIEF DESCRIPTION OF THE DRAWINGS

The present invention will become more fully apparent with reference to the following detailed description when considered in conjunction with the accompanying drawings, wherein:

FIG. 1 is a block diagram of multiprocessor system according to a conventional art;

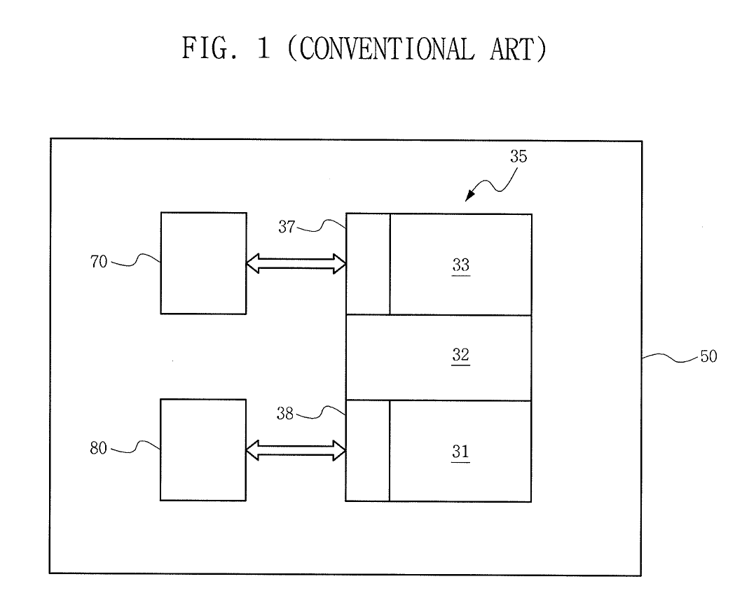

FIG. 2 is a block diagram schematically illustrating a multiprocessor system employing a multiport semiconductor memory device according to an exemplary embodiment of the invention;

FIG. 3 is a block diagram illustrating an exemplary embodiment of the semiconductor memory device shown in FIG. 2;

FIG. 4 shows an exemplary address assignment and access relationship between a register unit and memory banks in FIG. 3;

FIG. 5 illustrates an exemplary connection correlation of an interrupt driver unit and the register unit shown in FIG. 3;

FIG. 6 illustrates an example of multipath access to a shared memory area shown in FIG. 3 according to an exemplary embodiment of the present invention;

FIG. 7 is a block diagram illustrating an exemplary connection between a first port unit and a first path unit shown in FIG. 3; and

FIG. 8 is a circuit diagram illustrating an exemplary embodiment of an address multiplexer shown in FIG. 6.

### DETAILED DESCRIPTION OF THE EMBODIMENTS

Exemplary embodiments of the present invention will now be described with reference to the accompanying drawings. This invention may, however, be embodied in many different forms and should not be construed as limited to the embodiments set forth herein.

Exemplary embodiments of the present invention include a multiport semiconductor memory device, a multiprocessor system having the same, and an access method of the multiport semiconductor memory device. At least one of the embodiments may reduce the number of data transfer events between processors.

In an exemplary embodiment of the present invention, the multiprocessor system includes three processors and one multiport semiconductor memory device. The multiprocessor system may be employed within a single integrated circuit (IC) chip, thereby reducing the number of memory chips and reducing standby power. The multiport semiconductor memory device includes three port units, a shared memory area, and a data path control unit for controlling a data path between the shared memory area and the port units. The number of data transfer events between the processors can be reduced through use of the shared memory area, thereby improving a data processing speed of the multiprocessor system.

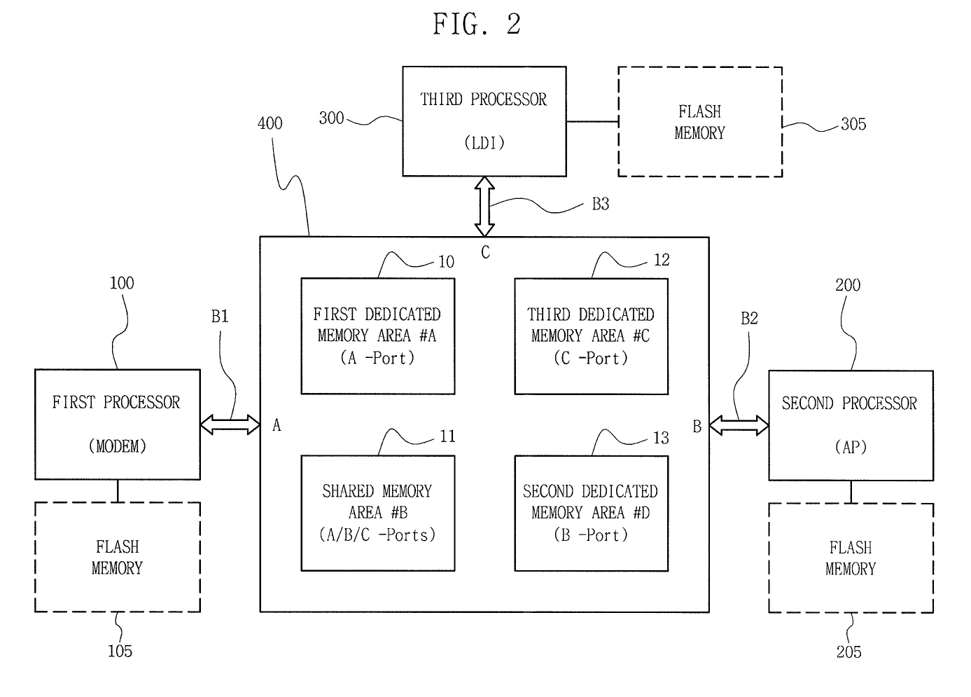

FIG. 2 is a block diagram schematically illustrating a multiprocessor system employing a multiport semiconductor memory device according to an exemplary embodiment of the invention. Referring to FIG. 2, one multiport semiconductor memory device 400 is coupled in common with first, second and third processors 100, 200 and 300 respectively through buses B1, B2 and B3. The first processor 100 may provide a function of a MODEM processor performing a predetermined task (e.g., modulation and demodulation of a communication signal). The second processor 200 may include an application processor to perform a user convenience function for communication data processing, games, etc. The third processor 300 may include a function to drive a Liquid Crystal Display (LCD) or a function to process image information.

A memory cell array of the multiport semiconductor memory device 400 includes four memory banks. A first bank of the plurality may function as a first dedicated memory area 10, which may be accessed dedicatedly by the first processor 100 through the first port A, A fourth bank of the plurality may function as a second dedicated memory area 13, which may be accessed dedicatedly by the second processor 200 through the second port B. Further, a third bank of the plurality may function as a third dedicated memory area 12, which may be accessed dedicatedly by the third processor 300 through the third port C.

A second bank of the plurality may function as a shared memory area 11, which may be accessed by all of the first, second and third processors 100, 200 and 300 through the first, second, third ports A, B, C as mutually different ports. As a result, in the memory cell array, the second bank 11 is assigned as a shared memory area, and the first, third and fourth banks 10, 12 and 13 are assigned as the dedicated memory areas that are respectively accessed only by each corresponding processor.

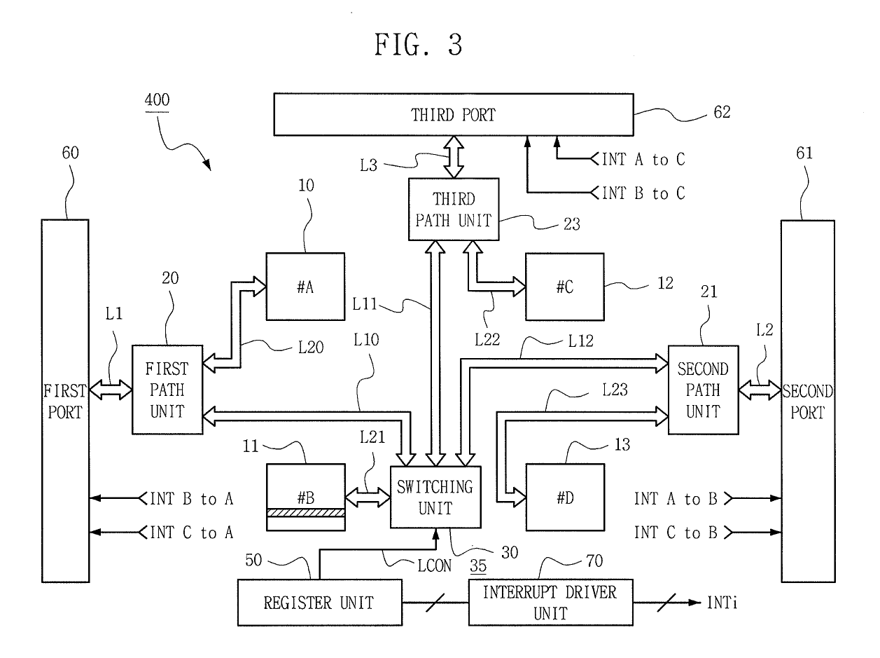

FIG. 3 is a block diagram of an exemplary embodiment of the semiconductor memory device shown in FIG. 2. Referring to FIG. 3, the multiport semiconductor memory device comprises at least three port units 60, 61 and 62 coupled respectively with the corresponding first, second and third processors 100, 200 and 300 shown in FIG. 2; a shared memory area 11 accessed in common by the processors 100, 200 and 300 through the three port units 60, 61 and 62; and a data path control unit 35 for controlling a data path between the shared memory area 11 and the port units 60, 61 and 62 to perform a data communication (e.g., data transmission and/or reception) between the processors 100, 200 and 300 through the shared memory area 11. The shared memory may be assigned to a predetermined memory capacity unit (e.g., in units of one or more banks) in a portion of the memory cell array.

In FIG. 3, the first, third and fourth banks 10,12 and 13 are individually accessed respectively by the processors 100, 200 and 300, which are coupled with the first, third and second ports 60, 62, 61 through corresponding lines L1, L3 and L2. The four memory areas 10, 11, 12 and 13 of FIG. 3 may be individually configured in a unit of a bank of a DRAM, and one bank may have a memory storage of, e.g., 16 Megabit (Mb), 32 Mb, 64 Mb, 128 Mb, 256 Mb, 512 Mb, 1024 Mb, etc.

The data path control unit 35 comprises an internal register 50. The internal register 50 may be accessed from a source that is external to the memory cell array, instead of a specific area of the shared memory area 11. For example, the internal register may be accessed by the external source when a specific address is applied to access the area shown by the cross hatching in the shared memory area 11. The internal register 50 may be used to store data needed for controlling the data path.

The data path control unit 35 further comprises an interrupt driver 70 and a switching unit 30. The interrupt driver 70 is coupled to the internal register 50, for applying respectively corresponding interrupt signals INTi to the port units to prevent two or more processors from simultaneously accessing the shared memory area 11. The switching unit 30 is coupled to the internal register 50, for switching a data path between the shared memory area 11 and a port unit corresponding to a processor having control authority among the port units.

The switching unit 30 selectively couples an input/output line L21 of the shared memory area 11 to one of input/output lines L10, L12 and L11 of first, second and third path units 20, 21 and 23 in response to a switching control signal LCON output from the register unit 50 as the internal register.

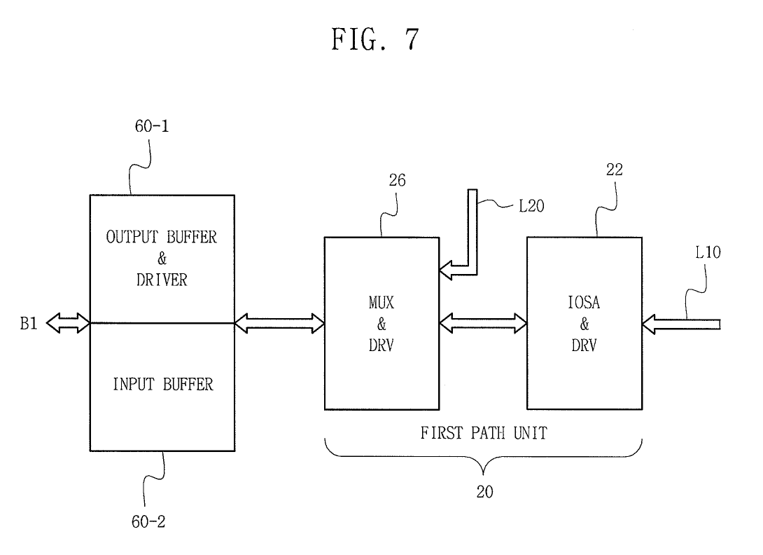

The first path unit 20 performs a function of switching a line L1 to one of input/output lines L10 and L20, and may include an input/output buffer as shown in FIG. 7. The second path unit 21 performs a function of switching a line L2 to one of input/output lines L12 and L23, and may include an input/output buffer as shown in FIG. 7. Further, the third path unit 23 performs a function of switching a line L3 to one of input/output lines L11 and L22, and may include an input/output buffer as shown in FIG. 7.

The interrupt driver generates interrupt signals INTi:INT B to A, INT C to A, INT A to B, INT C to B, INT A to C, INT B to C for application to the port units 60, 61 and 62. The interrupt signals INT B to A and INT C to A may be applied to the first port 60, the interrupt signals INT A to B and INT C to B may be applied to the second port 61, and the interrupt signals INT A to C and INT B to C may be applied to the third port 62.

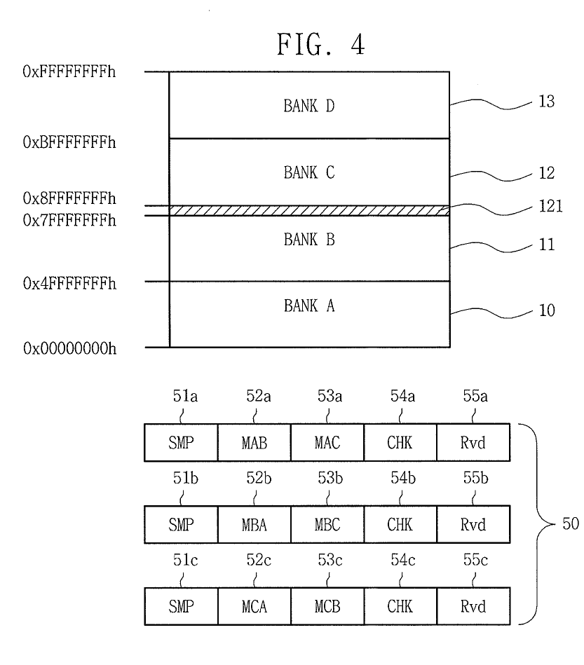

As shown in FIG. 4, the register unit 50 may comprise semaphore areas 51a, 51b, and 51c and mailbox areas 52a-c and 53a-c. The semaphore areas are for storing a control authority for the shared memory area 11. The mailbox areas 52a-c and 53a-c may be individually assigned in one-set units corresponding to the number of processors, for storing a message to be applied to respective processors corresponding to a data transmission direction.

FIG. 4 shows an exemplary address assignment and access relationship between the register unit and memory banks referred to in FIG. 3. For the following example, it will be assumed that respective banks 10-13 have a capacity of 16 Mb. Referring to FIG. 4, an area of bank B (11) to be the shared memory area is determined as a disable area 121. For example, a row address (0x7FFFFFFFh˜0x8FFFFFFFh, e.g., a size of 2 KB=the size of 1 row) for enabling one optional row of the shared memory area 11 within the DRAM is changeably assigned to the internal register 50 that functions as an interface unit. When the row address (e.g., 0x7FFFFFFFh˜0x8FFFFFFFh) is applied, a corresponding word line area 121 of the shared memory area 11 is disabled, while the internal register 50 is enabled. In an exemplary embodiment of the present invention, the semaphore areas 51a, 51b, 51c and mailbox areas 52a-c, 53a-c are accessed by using a direct address mapping method, and in an internal aspect of DRAM, a command sent to a corresponding disabled address is decoded, thus performing a mapping to a DRAM internal register. Thus, a memory controller generates a command for the areas through the same method as the other memory cells. In FIG. 4, the semaphore area 51a, the first mailbox area 52a (mail box A to B), and the second mailbox area 53b (mail box A to C) may be each assigned with 16 bits, and the check bit area 54a may be assigned with 4 bits. An area 55a may be assigned as 2 bits as a reserved area. The areas 51a, 52a, 53a, 54a and 55a may be arranged to correspond to the first port 60 of FIG. 3. The areas 51b, 52b, 53b, 54b and 55b may be arranged to correspond to the second port 61. The areas 51c, 52c, 53c, 54c and 55c may be arranged to correspond to the third port 62.

The areas 51a, 52a, 53a, 54a and 55a can be enabled in common by a specific row address, and may be individually accessed in response to an applied column address. In the register unit 50, semaphore areas 51a, 51b and 51c storing a control authority for the shared memory area 11 can be combined as one area having a storage capacity of 2 bits or more.

The internal register 50 is a storage area, which may be adapted separately from the memory cell array within the multiport DRAM 400, to determine an interface configuration between the processors. The internal register 50 may be accessed by all the processors 100, 200 and 300. The internal register 50 may comprise, for example, a flip-flop, a data latch, or a SRAM cell. For example, the semaphore area 51a, 51b, 51c and the mailbox areas 52a-c, 53a-c may include a latch type storage cell different from a memory cell of DRAM, which does not require a refresh operation.

For example, when a data interface between the first, second and third processors 100, 200 and 300 is obtained through the multiport DRAM 400, the first, second and third processors 100, 200 and 300 can write a message to a corresponding processor by using the mailboxes 52a-c and 53a-c. A processor of a receiving party, having read the written message, recognizes the message of the transmitting party, and performs its corresponding operation.

When the processors perform a data communication through the DRAM interface by utilizing the mailboxes 52a-c and 53a-c, a host interface may not be required or the number of host interfaces may be substantially reduced, thereby enabling a reduction in the size of the multi-processor system. Referring to FIG. 2, the multi-processor system may optionally include flash memories 105, 205, and 305 that respectively operatively connect to the processors 100, 200, and 300. The multiport DRAM 400 may indirectly access the flash memories 105, 205, and 305 by a processor that is not directly coupled to a respective flash memory.

The flash memories 105, 205, and 305 may include NAND and/or NOR flash memories. The flash memories 105, 205, and 305 may be non-volatile memories. Such non-volatile memories may be configured to store data that needs to be saved from deletion even when power is turned off. For example, such data may include program and boot codes of handheld devices and preservation data. The flash memories 105, 205, and 305 may include memory cells including one or more MOS transistors. At least one of the MOS transistors may have a floating gate.

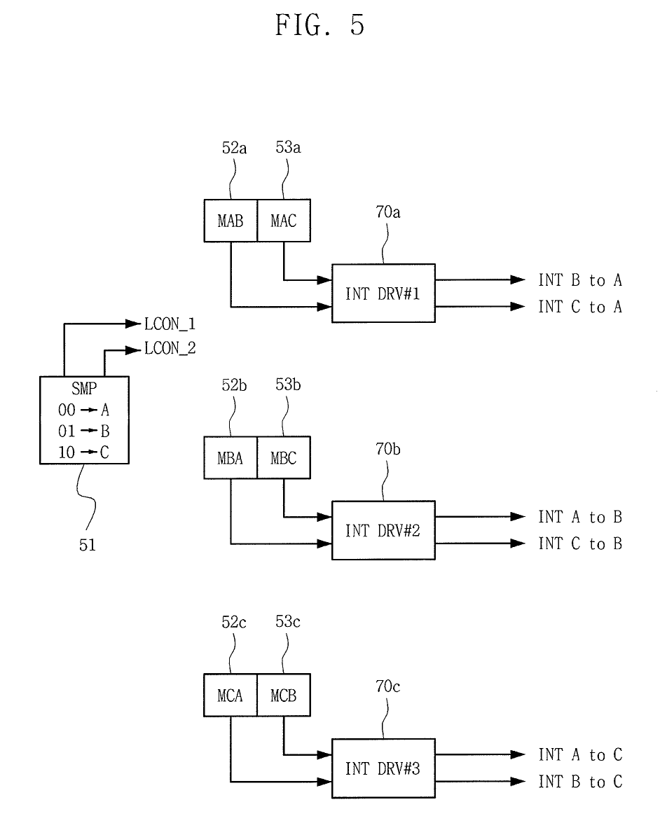

FIG. 5 illustrates an exemplary connection correlation of an interrupt driver unit and the register unit 50 shown in FIG. 3. Referring to FIG. 5, a control authority for the shared memory area 11 is written to a semaphore area 51. For example, when the first processor 100 has a control authority, data “00” may be written, when the second processor 200 has a control authority, data “01” may be written, and when the third processor 300 has a control authority, data “10” may be written. A switching signal LCON of FIG. 3 output from the semaphore area 51 may be embodied as first and second switching signals LCON_1, LCON_2 in FIG. 5. For example, when an output state of the first and second switching control signals LCON_1, LCON_2 is applied as “00”, the switching unit 30 of FIG. 3 may couple an input/output line L21 of shared memory area 11 shown in FIG. 3 to input/output lines L10 of the first path unit 20. The semaphore area 51 shown in FIG. 5 is a combined area of semaphore areas 51a, 51b and 51c shown in FIG. 4.

In FIG. 5, in first and second mailbox areas 52a and 53a, a message transmitted from the first processor 100 to the second and third processors 200 and 300 is written. The message may include, for example, an authority request, an address, a data size, or transmission data indicating an address of shared memory for storing data, commands, etc. For example, in the first mailbox area 52a, a message transmitted from the first processor 100 to the second processor 200 may be written. As a result, transmission mailboxes 52a and 53a of a first set are assigned to the first processor 100, and reception mailboxes 52b and 52c of a second set are assigned thereto. In the mailboxes 52b and 52c, messages to be transmitted to the first processor 100 from the second and third processors 200 and 300 may be individually written.

In FIG. 5, an exemplary embodiment of the interrupt driver unit 70 of FIG. 3 includes a first, second and third interrupt drivers 70a, 70b, and 70c. The first interrupt driver 70a is coupled to the first processor 100 through the first port 60, and the second interrupt driver 70b is coupled to the second processor 200 through second port 61. The third interrupt driver 70c is coupled to the third processor 300 through the third port 62. For example, interrupt signals INT B to A and INT C to A output from the first interrupt driver 70a may be interrupt signals requested respectively from the second and third processors 200 and 300. Though inputs of the first interrupt driver 70a are shown as being coupled with the first and second mailbox areas 52a and 53a, embodiments of the present invention are not limited thereto. For example, the first interrupt driver 70a may be coupled to the reception mailboxes 52b and 52c. The first and second mailbox areas 52a-c, 53a-c shown in FIG. 5 for the respective processors are the same as the mailboxes shown in FIG. 4, and thus are shown with the same reference numbers and characters.

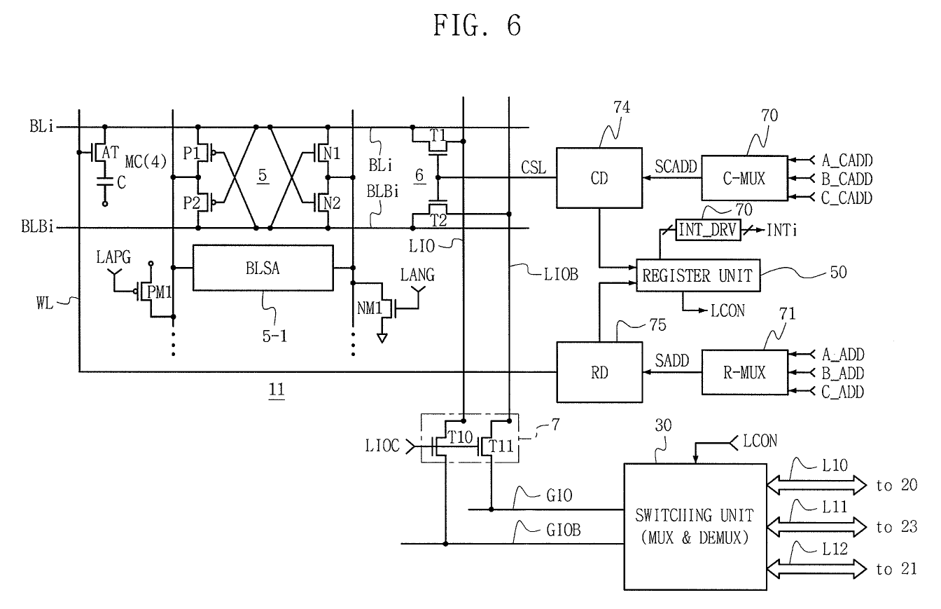

FIG. 6 illustrates an example of multipath access to the shared memory area shown in FIG. 3 according to an exemplary embodiment of the present invention. FIG. 7 is a block diagram illustrating an exemplary connection between a first port unit and a first path unit shown in FIG. 3, including a first port input/output sense amplifier and driver 22 and a first port multiplexer and driver 26.

In FIG. 6, a memory cell 4 (e.g., a DRAM cell) indicates a memory cell belonging to the shared memory area 11 of FIG. 3. With reference to the drawings, the shared memory area 11 is operationally coupled to one of the first, second and third path units 20, 21 and 23 through a switching operation of the switching unit 30.

The DRAM cell 4 includes an access transistor AT and a storage capacitor C, and serves as a memory unit. The DRAM cell 4 is coupled at intersections of pluralities of word lines and bit lines, thus constituting a bank array of a matrix type. A word line WL shown in FIG. 6 is disposed between a gate of the access transistor AT of the DRAM cell 4 and a row decoder 75. The row decoder 75 applies a row decoded signal to the word line WL and the register unit 50 in response to a selection row address SADD of a row address multiplexer 71. A bit line BLi including a bit line pair is coupled to a drain of the access transistor AT and a column selection transistor T1. A complementary bit line BLBi is coupled to a column selection transistor T2. PMOS transistors P1 and P2 and NMOS transistors N1 and N2 coupled to the bit line pair BLi, BLBi constitute a bit line sense amplifier 5. Sense amplifier driving transistors PM1 and NM1 each receive corresponding drive signals LAPG, LANG, and drive the bit line sense amplifier 5. A column selection gate 6 comprised of column selection transistors T1 and T2 is coupled to a column selection line CSL transferring a column decoded signal of a column decoder 74. The column decoder 74 applies a column decoded-signal to the column selection line and the register unit 50 in response to a selection column address SCADD of a column address multiplexer 70.

In FIG. 6, a local input/output line pair LIO, LIOB is coupled to a first multiplexer 7. When transistors T10 and T11 constituting the first multiplexer 7 are turned on in response to a local input/output line control signal LIOC, the local input/output line pair LIO, LIOB is coupled to a global input/output line pair GIO, GIOB. Then, data of the local input/output line pair LIO, LIOB is transferred to the global input/output line pair GIO, GIOB in a read operating mode of data. In a write operating mode of data, write data applied to the global input/output line pair GIO, GIOB is transferred to the local input/output line pair LIO, LIOB. The local input/output line control signal LIOC may be a signal generated in response to a decoded signal output from the row decoder 75.

Read data transferred to the global input/output line pair GIO, GIOB is transferred to a corresponding input/output sense amplifier and driver 22 through one of lines L10, L11 and L12 as shown in FIG. 7. The input/output sense amplifier 22 serves to amplify data whose level has been weakened according to the transfer steps through several data paths. Read data output from the input/output sense amplifier 22 is transferred to the first port 60 through the multiplexer and driver 26 that constitutes the first path unit 20 together with the input/output sense amplifier 22 as shown in FIG. 7. When the shared memory area 11 is accessed by the first processor 100, the second and third processors 200 and 300 are decoupled from the lines L12 and L11, and thus an access operation of the second and third processors 200 and 300 to the shared memory area 11 is intercepted. However, in this example, the second and third processors 200 and 300 can access the dedicated memory areas 13 and 12 through the second and third ports 61 and 62.

In a write operation, write data applied through the first port 60 is transferred to the global input/output line pair GIO, GIOB sequentially through an input buffer 60-2 of FIG. 7, the multiplexer and driver 26, the input/output sense amplifier and driver 22 and the switching unit 30. When the first multiplexer 7 is activated, the write data is transferred to the local input/output line pair LIO, LIOB and is stored in a selected memory cell 4.

An output buffer and driver 60-1 and the input buffer 60-2 shown in FIG. 7 may correspond to or be included in the first port 60 of FIG. 3. Further, the input/output sense amplifier and driver 22 and the multiplexer and driver 26 may correspond to or be included in the first path unit 20 of FIG. 3. The multiplexer and driver 26 can prevent one processor from simultaneously accessing the shared memory area 11 and a dedicated memory area (e.g., 10,12, or 13).

In a semiconductor memory device according to the embodiment shown in FIG. 7, a DRAM interface function between processors 100, 200 and 300 can be attained since three processors can access in common the shared memory area 11. Furthermore, the processors 100, 200 and 300 can perform a data communication through the commonly accessible shared memory area by using the internal register 50 functioning as an interface unit.

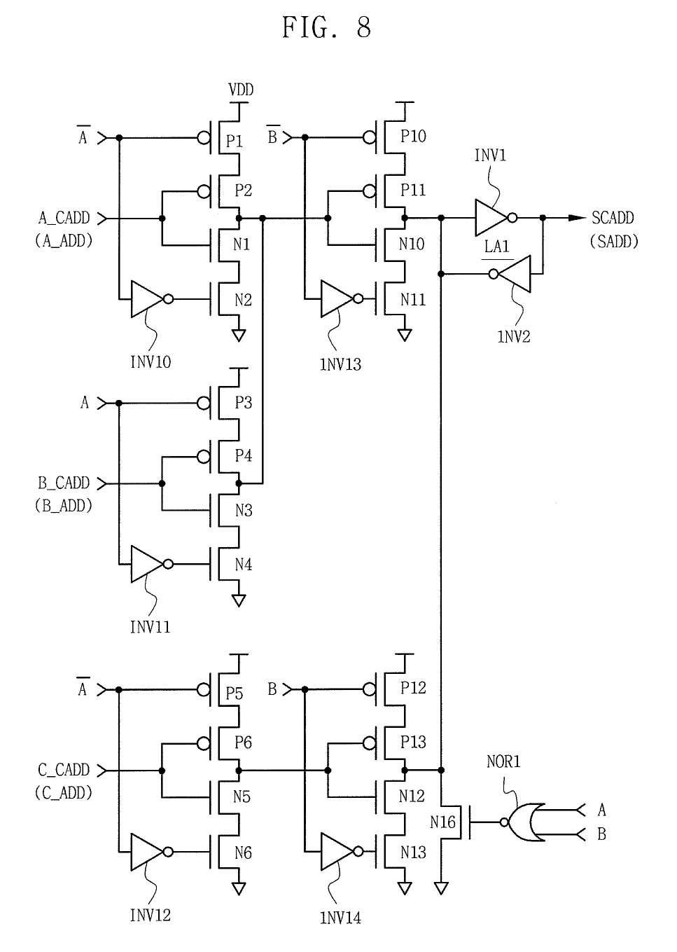

FIG. 8 is a circuit diagram illustrating an exemplary embodiment of an address multiplexer shown in FIG. 6. FIG. 9 illustrates as an example, one of the row address multiplexer 71 and the column address multiplexer 70 shown in FIG. 6. For example, each address multiplexer may be realized using the same circuit devices, and functions as a row address multiplexer or a column address multiplexer according to a kind of input signal.

With reference to FIG. 8, the column address multiplexer 70 comprises clocked-CMOS inverters comprised of PMOS and NMOS transistors P1-P13 and N1-N13, and an inverter latch LA1 comprised of inverters INV1 and INV2. The column address multiplexer 70 is configured to individually receive three column addresses A_CADD, B_CADD and C_CADD provided respectively from one of three ports to one of three input terminals thereof. The column address multiplexer is configured to select one of the three column addresses A_CADD, B_CADD, or C_CADD according to a logic state of path decision signals A, /A, B, /B and output it as a selection column address SCADD. An NMOS transistor N16 and a NOR gate NOR1 are configured to provide a discharge path between an input terminal of the inverter latch LA1 and a ground. Inverters INV10-14 are configured individually to invert a logic state of the path decision signals A, /A, B, /B.

In FIG. 8, for example, when the path decision signals /A and /B are both applied with a logic low level, the column address A_CADD of FIG. 6 applied through the first port 60 of FIG. 3 is inverted sequentially through an inverter comprising PMOS and NMOS transistors P2 and N1 and an inverter comprising PMOS and NMOS transistors P11 and N10, and is again inverted by the inverter INV1. As a result, the column address A_CADD is output as the selection column address SCADD. In this example, the path decision signals A, B are applied in a logic high level, and thus the column address B_CADD, which may be applied through the second port 61, is not provided to an input terminal of the latch LA1 since the inverter comprising PMOS and NMOS transistors P4 and N3 has an inactive state. As a result, the column address B_CADD, which may be applied through the second port 61, is not output as the selection column address SCADD. Further, the column address C_CADD, which may be applied through the third port 62, is not provided to an input terminal of the latch LA1 since the inverter comprising PMOS and NMOS transistors P6 and N5 has an inactive state. For example, the column address C_CADD, which may be applied through the third port 62, is not output as the selection column address SCADD and thus cannot access the shared memory area 11. Further, in FIG. 8, when an output of the NOR gate NOR1 transitions to a high level, the NMOS transistor N16 is turned on and a logic level latched to the latch LA1 is initialized to a low level.

Referring back to FIG. 2, one multiport semiconductor memory device 400 may be used as a main memory for the first, second and third processors 100, 200 and 300 within a multiprocessor system, thereby reducing the number of memory chips comprising the system. Standby power consumed in a standby operation of the system can be reduced since the number of memory chips has been reduced.

An example of a reduction in the number of data transfer events between processors through a use of the shared memory area 11 will be provided mainly with reference to FIG. 3. When the number of data transfer events is reduced, a data processing speed of the system may be increased.

In FIG. 3, for example, it may be assumed that the first processor 100 coupled to the first port 60 is a processor performing a first task such as a communication modulation/demodulation function, that the second processor 200 coupled to the second port 61 is an application processor performing a second task such as a multimedia information processing function, and that the third processor 300 coupled to the third port 62 is an image processor performing a third task such as processing an image provided from a charge coupled device (CCD) or a CMOS Image Sensor (CIS).

For example, when a user of the multiprocessor system photographs an image in a camera mode and transmits the image to an image phone of a friend, a channel is formed that connects the third processor 300 to the shared memory through the third port 62, the third path unit 23, and the switching unit 30. For example, when the switching unit 30 operationally couples a line L21 to a line L11 through a path control of the register unit 50, the shared memory area 11 may be accessed by the third processor 300. In this example, flag data “10” indicating that the third processor 300 has the control authority may be represented in the semaphore area 51 of FIG. 5. While the third processor 300 has the control authority, the first and second processors 100 and 200 cannot access the shared memory area 11, but can access the respective dedicated memory areas 11 and 13.

The third processor 300 having the control authority can write original image data obtained from the CCD to a storage area of the shared memory area 11. Since it may be difficult to transmit the original image data directly through a communication network, a processing for a data compression or a transmission format may be additionally performed. In at least one embodiment of the invention, the original image data need not be read from the shared memory area 11, and need not be transmitted to the second processor 200 for additional processing. For example, in a state that the original image data is intact in the storage area of the shared memory area 11, the second processor 200 accesses the shared memory area 11. As a result, the original image data stored in the shared memory area 11 is directly available for a data processing by an access of the second processor 200 on the shared memory area 11 without a transmission to another processor for the data processing. For such execution, when a write operation of the original image data is completed, the third processor 300 writes a message to the second mailbox 53c directed to the second processor 200 described in FIG. 5. The message may be a data size of the original image data, a start address and end address for the written original image data, or a command requiring a data processing. The second processor 200 reads the second mailbox 53c and then writes a signal to the second mailbox 53b of the second processor 200, the signal indicating that the message has been read. When an interrupt signal INT B to C requiring an interrupt of the third processor 300 is generated, flag data of the semaphore area 51 is changed to “01”. Thus, the second processor 200 has the control authority for the shared memory area 11.

The second processor 200 accesses the original image data and compresses the image data in a predetermined image data compression format, and formats it in a transmission format. The format-processed image data is also stored in the shared memory area 11.

When the data processing operation of the second processor 200 is completed, a message is written to a first mailbox 52b directed to the first processor 100 described in FIG. 5. The message may be a data size of the format-processed image data, a start address and end address of the written image data, or a command requiring a data transmission. The first processor 100 reads the first mailbox 52b and then writes a signal to the first mailbox 52a of the first processor 100, the signal indicating that the message has been read. When an interrupt signal INT A to B requiring an interrupt of the second processor 200 is generated, the flag data of the semaphore area 51 is changed to “00”. Thus, the first processor 100 has the control authority for the shared memory area 11.

The first processor 100 reads the format-processed image data and transmits the data by radio in a frequency matched to a predetermined communication frequency band through an antenna of the multiprocessor system. Then the image transmitted by the user of the system may be displayed on the image phone of the friend.

As described above, the number of data transfer events between processors may be reduced by using the shared memory area 11. For example, in at least one embodiment of the invention, there is no data transfer between processors except the transmission to external sources through a communication processor.

Further, data written to the shared memory area by an optional processor among the processors can be directly accessed and processed by another processor without being transmitted to the another processor.

In at least one embodiment of the multiprocessor system, the number of processors may increased to four or more. In the multiprocessor system, the processor may be a microprocessor, CPU, digital signal processor, micro controller, reduced-command set computer, complex command set computer, or the like. It is noted herein that the scope of the disclosure is not limited to any number of processors in the system. Further, the scope of the disclosure is not limited to any specific combination of processors in employing the same or different processors.

It will be apparent to those of ordinary skill in the art that modifications and variations can be made in the present invention without deviating from the spirit or scope of the disclosure. Thus, it is intended that the present invention cover any such modifications and variations. For example, the configuration for a shared memory bank of the multiport semiconductor memory device or circuit configuration and access method may be diversely changed.

Further, a data path control to control a data path between the shared memory area and the port units may be realized by various methods. While the above describes the nonvolatile memory as a flash memory and a volatile memory configured as a multiport DRAM, the present invention is not limited thereto. For example, embodiments of the invention can be applied to other nonvolatile memory, such as PRAM, a static random access memory, etc.

While exemplary embodiments of the present invention have been described, it is to be understood that the present invention is not limited to these exemplary embodiments, but that various changes can modifications can be made by one of ordinary skill in the art within the spirit and scope of the disclosure.

What is claimed is:

1. A multiport semiconductor memory device comprising:
at least three port units coupled respectively to corresponding processors;
a memory cell array comprising a shared memory area accessed in common by the processors through the port units; and
a data path control unit for controlling a data path between the shared memory area and the port units to perform a data communication between the processors through the shared memory area.

2. The device of claim 1, wherein the memory cell array further comprises dedicated memory areas dedicatedly accessed by the processors.

3. The device of claim 2, wherein the data path control unit comprises an internal register for storing data needed for a control of the data path.

4. The device of claim 3, wherein the internal register is accessed by a source external to the memory cell array when an address to access an area of the shared memory is applied.

5. The device of claim 3, wherein the internal register comprises a semaphore area for storing a control authority among the port units for the shared memory area.

6. The device of claim 5, wherein the internal register further comprises mailbox areas individually assigned to each of the processors, the mailbox areas being for storing a message to be applied to respective processors corresponding to a data transmission direction.

7. The device of claim 1, wherein the data path control unit comprises:
an internal register accessed for storing data needed for a control of the data path;
an interrupt driver coupled to the internal register, for applying interrupt signals corresponding to the respective port units to prevent two or more of the processors from simultaneously accessing the shared memory area; and
a switching unit coupled to the internal register, for switching a data path between the shared memory area and a port unit corresponding to a processor having a control authority among the port units.

8. The device of claim 1, wherein data written to the shared memory area by a first processor among the processors is available for a data processing in the shared memory area by a second processor among the processors without a transmission to the second processor for a data processing, and the processed data is transmitted to a communication processor.

9. A multiprocessor system, comprising:
a first processor for performing a first task;
a second processor for performing a second task;
a third processor for performing a third task; and
a multiport semiconductor memory device comprising:
first, second and third port units individually coupled to the corresponding processors;
a shared memory area accessed in common by the processors through the port units; and
a data path control unit for controlling a data path between the shared memory area and the port units to perform a data communication between the processors through the shared memory area.

10. The system of claim 9, wherein the first task comprises a communication modulation/demodulation (MODEM) function.

11. The system of claim 10, wherein the second task comprises a function of processing multimedia information.

12. The system of claim 11, wherein the third task comprises a function of processing image information provided from a charge-coupled device.

13. The system of claim 12, wherein the multiprocessor system is one of a vehicle-use mobile phone, a portable multimedia player (PMP), a personal digital assistant (PDA), or a portable phone.

14. The system of claim 9, further comprising a NAND type flash memory that is accessed by the second processor.

15. A method of accessing a multiport semiconductor memory device in a multiprocessor system, wherein the multiport semiconductor memory device is operationally coupled with first, second and third processors, the method comprising:
controlling port units of the multiport semiconductor memory device to write data to a shared memory area of the memory device using the first processor;
controlling the port units to access the shared memory area by the second processor and performing a processing of the written data in the shared memory area; and
controlling the port units to access the shared memory area by the third processor and transmit the converted data to a source external to the system.

16. The method of claim 15, wherein when the first processor is a communication processor and the second processor is an application processor, the third processor is an image processing processor.

17. The method of claim 15, wherein the multiprocessor system is one of vehicle-use mobile phone, a portable media player, a personal digital assistance PDA, or a portable phone.

18. The method of claim 15, wherein the controlling of the port units is performed by using an internal register for storing data needed for a switching of the port units.

19. The method of claim 18, wherein the internal register is accessed by the external source when an address to access an area of the shared memory is applied.

20. The method of claim 18, wherein the internal register comprises a semaphore area for storing a control authority among the port units for the shared memory area.
